(19) United States
(12) Patent Application Publication
(10) Pub. No.: US 2026/0363265 A1
(43) Pub. Date: Nov. 19, 2026

(54) GUMMY CANDY AND METHOD FOR PRODUCING THE SAME

(71) Applicant: KABAYA FOODS CORPORATION, Okayama-shi (JP)

(72) Inventor: Kazuma OKABE, Okayama-shi (JP)

(73) Assignee: KABAYA FOODS CORPORATION, Okayama-shi (JP)

(21) Appl. No.: 19/236,440

(22) Filed: Jun. 12, 2025

(30) Foreign Application Priority Data
May 19, 2025 (JP) 2025-083325

(51) Int. Cl. A23G 3/34; A23G 3/42

(52) U.S. Cl. CPC A23G 3/0053; A23G 3/0085; A23G 3/42

(57) ABSTRACT

Provided is a gummy candy that has a crunchy texture and elasticity of typical gummy candies. Also provided is a method for producing such a gummy candy. A gummy candy is produced by a method including: a gummy base preparation step of heating a carbohydrate raw material and a gelling agent to obtain a gummy base; an addition step of adding carbohydrate crystals to the gummy base to obtain a gummy dough; and a drying step of filling a mold with the gummy dough and drying the gummy dough.

### CROSS-REFERENCE TO RELATED APPLICATIONS

This application claims the priority benefit under 35 U.S.C. § 119 of Japanese Patent Application No. 2025-083325 filed on May 19, 2025, which is hereby incorporated in its entirety by reference.

### BACKGROUND OF THE INVENTION

### Field of the Invention

The present disclosure relates to a gummy candy and a method for producing the same.

### Description of Related Art

There is a conventional technique for obtaining a gummy candy that exhibits a crunchy texture when masticated, and this technique involves dissolving erythritol, which is a carbohydrate crystal, in a base dough of the gummy candy, filling a starch mold with the resulting base dough, and then crystallizing the erythritol. In addition, another known gummy candy is formed by covering the surface of a gummy with carbohydrate crystals.

### CITATION LIST

### Patent Literature

Non Patent Literature 1: https://www.kasugai.co.jp/product/mochira-1/
Non Patent Literature 2: https://www.bourbon.co.jp/product/detail/35388-01.html

### Brief Summary of the Invention

In the conventional technique described above, erythritol, which is a carbohydrate crystal that imparts the texture, is first dissolved and incorporated into the base dough and then crystallized. Therefore, fine crystals of erythritol are present in the entire base dough of the gummy candy. Therefore, there is a problem in that the crystals of erythritol become small, resulting in a crispy texture rather than a crunchy texture, and that the elasticity, a key characteristic of gummy candies, is weak.

Gummy candies in which carbohydrate crystals are attached to the surface have a problem that the carbohydrate crystals at the surface are likely to be left on the hands when the gummy candies are taken in the hands and eaten.

An object of the present disclosure is to provide a gummy candy that has a crunchy texture and the elasticity of typical gummy candies and that is less likely to leave carbohydrate crystals on the hands. Also provided is a method for producing such a gummy candy.

The present disclosure relates to a method for producing a gummy candy, this method including:
a gummy base preparation step of heating a carbohydrate raw material and a gelling agent to obtain a gummy base;
an addition step of adding carbohydrate crystals to the gummy base to obtain a gummy dough; and
a drying step of filling a mold with the gummy dough and drying the gummy dough.

The present disclosure provides a gummy candy produced by the above-described production method, and the carbohydrate crystals in this gummy candy are crystals of at least one selected from the group consisting of erythritol, trehalose, sugar, and maltitol.

In the present disclosure, the carbohydrate crystals may have a size that keeps them from passing through a sieve having a mesh size of 150 μm.

In the present disclosure, the carbohydrate crystals may have a size that allows them to pass through a sieve having a mesh size of 600 μm but keeps them from passing through a sieve having a mesh size of 150 μm.

The present disclosure also provides a gummy candy containing carbohydrate crystals, in which:
when the gummy candy is cut and a cross section of an inner region of the gummy candy is observed with an optical microscope at a magnification of 100,
two or more of the carbohydrate crystals having a particle size of 0.2 mm or more are present in an arbitrary 2 mm×2 mm region.

In the present disclosure, the carbohydrate crystal may be a crystal of erythritol.

In the present disclosure, the carbohydrate crystal may be a crystal of trehalose.

In the present disclosure, the carbohydrate crystal may be a crystal of sugar.

In the present disclosure, the carbohydrate crystal may be a crystal of maltitol.

According to the present disclosure, the carbohydrate crystals are added in the addition step after the heating step. As a result, the carbohydrate crystals are not excessively dissolved, so that relatively large carbohydrate crystals are dispersed in the gummy dough. Therefore, it is possible to provide a gummy candy that has a crunchy texture and a certain elasticity, and that is less likely to leave the carbohydrate crystals on the hands, as well as a method for producing such a gummy candy.

### BRIEF DESCRIPTION OF THE DRAWINGS

These and other characteristics, features, and advantages of the present disclosure will become clear from the following description with reference to the accompanying drawings, wherein:

FIG. 1 is a vertical cross-sectional view of a gummy candy 1 according to one embodiment;

FIG. 2 is a cross-sectional view showing a state in which a starch mold 5 has been filled with a first gummy dough and a second gummy dough;

FIG. 3 is a microscopic image of a cross section of a gummy candy of Example 1 captured at a magnification of 100;

FIG. 4 is a microscopic image of a cross section of a gummy candy of Example 2 captured at a magnification of 100;

FIG. 5 is a microscopic image of a cross section of a gummy candy of Example 3 captured at a magnification of 100;

FIG. 6 is a microscopic image of a cross section of a gummy candy of Example 4 captured at a magnification of 100;

FIG. 7 is a microscopic image of a cross section of a gummy candy of Example 5 captured at a magnification of 100;

FIG. 8 is a microscopic image of a cross section of a gummy candy of Example 6 captured at a magnification of 100;

FIG. 9 is a microscopic image of a cross section of a gummy candy of Example 7 captured at a magnification of 100;

FIG. 10 is a microscopic image of a cross section of a gummy candy of Example 8 captured at a magnification of 100;

FIG. 11 is a microscopic image of a cross section of a gummy candy of Example 9 captured at a magnification of 100;

FIG. 12 is a microscopic image of a cross section of a gummy candy of Example 10 captured at a magnification of 100;

FIG. 13 is a microscopic image of a cross section of a gummy candy of Example 11 captured at a magnification of 100;

FIG. 14 is a microscopic image of a cross section of a gummy candy of Example 12 captured at a magnification of 100;

FIG. 15 is a microscopic image of a cross section of a gummy candy of Example 13 captured at a magnification of 100;

FIG. 16 is a microscopic image of a cross section of a gummy candy of Example 14 captured at a magnification of 100;

FIG. 17 is a microscopic image of a cross section of a gummy candy of Example 15 captured at a magnification of 100;

FIG. 18 is a microscopic image of a cross section of a gummy candy of Example 16 captured at a magnification of 100;

FIG. 19 is a microscopic image of a cross section of a gummy candy of Example 17 captured at a magnification of 100;

FIG. 20 is a microscopic image of a cross section of a gummy candy of Example 18 captured at a magnification of 100;

FIG. 21 is a microscopic image of a cross section of a gummy candy of Example 19 captured at a magnification of 100;

FIG. 22 is a microscopic image of a cross section of a gummy candy of Example 20 captured at a magnification of 100;

FIG. 23 is a microscopic image of a cross section of a gummy candy of Example 21 captured at a magnification of 100;

FIG. 24 is a microscopic image of a cross section of a gummy candy of Example 22 captured at a magnification of 100;

FIG. 25 is a microscopic image of a cross section of a gummy candy of Example 23 captured at a magnification of 100;

FIG. 26 is a microscopic image of a cross section of a gummy candy of Example 24 captured at a magnification of 100;

FIG. 27 is a microscopic image of a cross section of a gummy candy of Comparative Example 1 captured at a magnification of 100;

FIG. 28 is a microscopic image of a cross section of a gummy candy of Comparative Example 2 captured at a magnification of 100;

FIG. 29 is a microscopic image of a cross section of a gummy candy of Comparative Example 3 captured at a magnification of 100;

FIG. 30 is a microscopic image of a cross section of a gummy candy of Comparative Example 4 captured at a magnification of 100; and

FIG. 31 is a microscopic image of a cross section of a gummy candy of Comparative Example 5 captured at a magnification of 100.

### DETAILED DESCRIPTION OF THE INVENTION

### Gummy Candy:

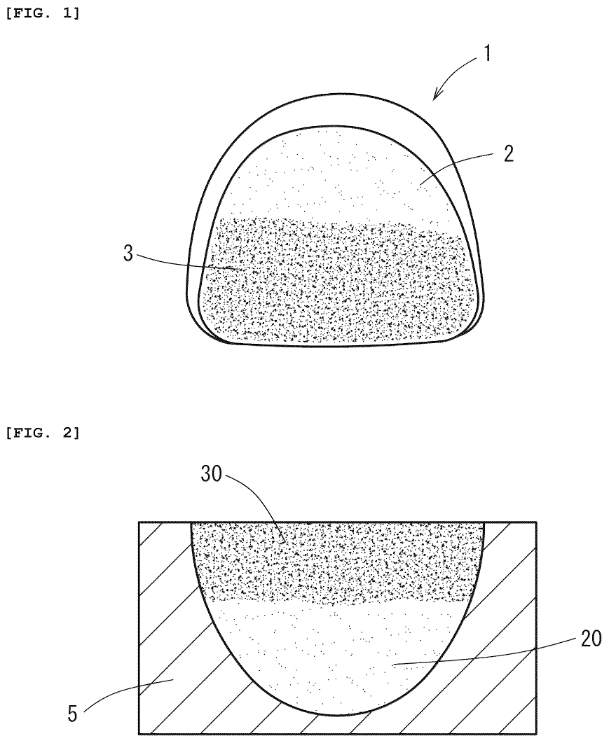

FIG. 1 is a cross-sectional view of a gummy candy 1 according to an embodiment of the present disclosure. As shown in FIG. 1, the gummy candy 1 includes a first gummy portion 2 and a second gummy portion 3.

Although not particularly limited, the first gummy portion 2 is configured to include a carbohydrate raw material and a gelling agent. Examples of the carbohydrate raw material include: monosaccharides such as glucose, fructose, and xylose; disaccharides or higher polysaccharides such as sugars (e.g., superfine sugar, granulated sugar, and powdered sugar), lactose, isomerized lactose, maltose, trehalose, oligosaccharides, dextrin, indigestible dextrin, polydextrose, and starch syrup; and sugar alcohols such as xylitol, maltitol, reduced isomaltulose (reduced palatinose (palatinit)), sorbitol, mannitol, erythritol, reduced lactose, and reduced starch syrup.

Examples of the gelling agent include bovine gelatin, porcine gelatin, fish gelatin, pectin, gum arabic, an alginic acid salt, carrageenan, agar, starch, guar gum, locust bean gum, xanthan gum, and gellan gum.

The first gummy portion 2 may also contain fruit juice or the like, and may contain other additives such as an acidulant, a colorant, and a flavor.

The second gummy portion 3 is configured to include the above-described carbohydrate raw material, gelling agent, and carbohydrate crystals. The second gummy portion 3 may also contain fruit juice or the like, and may contain other additives such as an acidulant, a colorant, and a flavor.

Examples of the carbohydrate crystals include erythritol crystals, trehalose crystals, maltitol crystals, and crystals of sugars (e.g., superfine sugar, granulated sugar, and powdered sugar).

Another aspect of the gummy candy 1 according to the present disclosure may include an example in which the entire gummy candy 1 is formed only of the second gummy portion 3. Yet another aspect of the gummy candy 1 may include an example in which the gummy candy 1 includes a portion of the second gummy portion 3 and two or more portions made of the first gummy portion 2.

### Method for Producing Gummy Candy:

A method for producing the gummy candy 1 according to the present embodiment will now be described. The present production method includes: a gummy base preparation step of heating a carbohydrate raw material and a gelling agent to obtain a gummy base; an addition step of adding carbohydrate crystals to the gummy base to obtain a gummy dough; and a drying step of filling a mold with the gummy dough and drying the gummy dough.

The gummy candy 1 may be produced by filling a starch mold 5 with the first gummy portion 2 and the second gummy portion 3 and drying them.

### First Gummy Portion:

A method for producing the first gummy portion 2 will be described first. A gelling agent (e.g., gelatin, pectin, gum arabic, alginic acid salt, or the like) is added to water that has been heated and stirred to prepare a gelling agent solution. Conditions such as a temperature and a stirring time for preparing the gelling agent solution can be adjusted as appropriate, as long as the added components can be sufficiently dissolved.

Subsequently, respective raw materials such as the prepared gelling agent solution, a carbohydrate raw material (for example, sorbitol, starch syrup, sugar, or the like), and water are weighed. After the weighing, the respective raw materials are placed in a predetermined mixer for mixing. At this time, heating the resulting mixed solution to temperatures from 100 °C to 120 °C can produce a first gummy base which is the base of the first gummy portion 2. Subsequently, an acidulant, fruit juice, a colorant, a flavor, and water are added to the resulting first gummy base, and mixed. Thus, a first gummy dough 20 is obtained.

### Second Gummy Portion:

A method for producing the second gummy portion 3 will now be described. A gelling agent (e.g., gelatin, pectin, gum arabic, alginic acid salt, or the like) is added to water that has been heated and stirred to prepare a gelling agent solution. Conditions such as a temperature and a stirring time for preparing the gelling agent solution can be adjusted as appropriate, as long as the added components can be sufficiently dissolved.

Subsequently, respective raw materials such as the prepared gelling agent solution, a carbohydrate raw material (for example, sorbitol, starch syrup, sugar, or the like), and water are weighed. After the weighing, the respective raw materials are placed in a predetermined mixer for mixing. At this time, heating the resulting mixed solution from 100 °C to 120 °C can produce a second gummy base which is the base of the second gummy portion 3 (corresponding to the “gummy base preparation step” in claims).

Subsequently, a carbohydrate crystal, an acidulant, fruit juice, a colorant, a flavor, and water are added to the resulting second gummy base, and mixed. Thus, a second gummy dough 30 is obtained (corresponding to the “addition step” in claims).

FIG. 2 is a cross-sectional view showing a state in which the starch mold 5 has been filled with the first gummy dough 20 and the second gummy dough 30. After the first gummy dough 20 and the second gummy dough 30 are produced, the starch mold 5 is filled with the first gummy dough 20 and the second gummy dough 30 and left standing for several tens of hours so that they are naturally dried. After natural drying (corresponding to the “drying step” in claims), this gummy candy is taken out from the starch mold 5. Thus, the gummy candy 1 is obtained. Finally, the gummy candy 1 is packaged with packaging such as a plastic bag or a pouch using a predetermined packaging machine. The gummy base preparation step may be a method in which the carbohydrate raw material and the gelling agent are separately heated and then mixed together.

### EXAMPLES

Specific examples of the second gummy dough 30 in the gummy candy 1 described above will be described below. However, the present disclosure is not limited and restricted by the following examples.

### Example 1

### (1) Gummy Dough

To a mixture containing 44.4 parts by mass of starch syrup, 31.0 parts by mass of sugar, 0.8 parts by mass of sorbitol, 4.9 parts by mass of gelatin, and 0.1 parts by mass of pectin, 14.3 parts by mass of water was added and mixed together. The mixture was boiled down, so that the Brix value thereof was adjusted to B×81. After that, 1.4 parts by mass of other additives and 3.1 parts by mass of water were added to adjust the Brix value thereof to B×80, and as a result, a gummy base was obtained. To 88.3 parts by mass of the gummy base, 7.7 parts by mass of erythritol crystals as carbohydrate crystals was added at 70 °C, and the resultant was mixed with a silicon spatula for 30 seconds or until the mixture was sufficiently mixed to obtain a gummy dough.

### (2) Filling and Molding

A starch mold was filled with the gummy dough using a dropper and was left standing until the gummy dough was sufficiently dried. After the gummy dough was sufficiently solidified and dried, the gummy candy was taken out from the starch mold, and a release oil composed of a vegetable fat or oil and a brightener was applied to the surface of the gummy candy to obtain a gummy candy of Example 1.

### (3) Classification of Carbohydrate Crystals

The carbohydrate crystals of erythritol used in this Example were those which passed through a sieve having a mesh size of 250 μm (JIS test popular sieve manufactured by Sieve Factory Iida Co., Ltd.) and did not pass through a sieve having a mesh size of 150 μm. Here, the size that satisfies the classification condition of 150 μm<size≤250 μm is defined as small (“S” in the table).

### (4) Cross-Sectional Observation

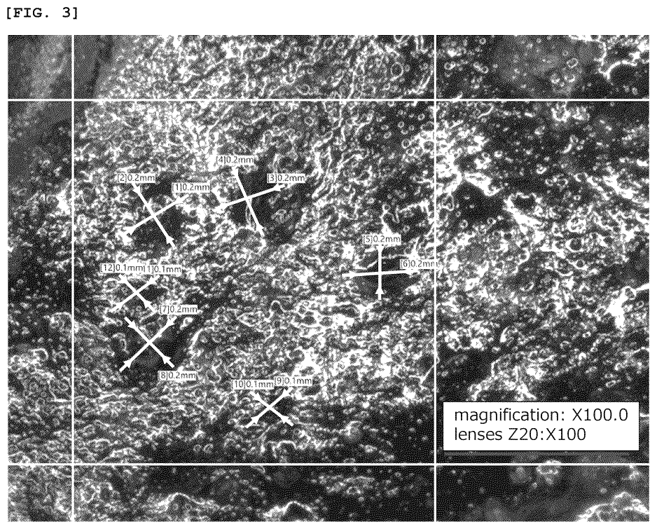

The gummy candy of Example 1 was cut with a cutter to prepare three cut pieces having a thickness of 1 mm from an optional inner region of the gummy candy. Using a digital microscope (KEYENCE VHX-970FN manufactured by KEYENCE CORPORATION), the cross section of each cut side was captured at a magnification of 100. One of the microscopic images obtained is shown in FIG. 3. For each of the captured images, the number and particle size of the carbohydrate crystals present within a 4 mm\hat{ }2 (2 mm×2 mm) frame were measured. The average number was 5.33 (pieces), and the average particle size was 0.21 mm. Here, the “particle size” used in the present disclosure refers to a value obtained by taking the average of the diameter in the longitudinal direction and the diameter in the transverse direction, which is perpendicular to the longitudinal direction, of the carbohydrate crystal that can be visually observed in a captured image.

### Example 2

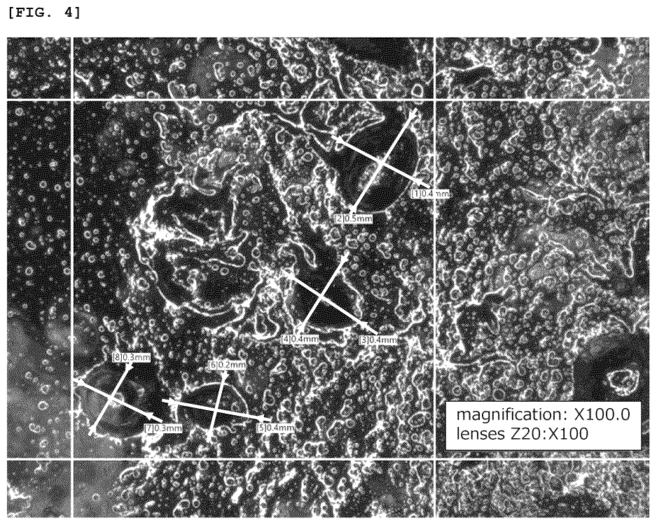

A gummy candy of Example 2 was obtained in the same manner as that in Example 1 except that the erythritol crystals used as the carbohydrate crystals were changed to those that passed through a sieve having a mesh size of 425 μm and did not pass through a sieve having a mesh size of 250 μm. FIG. 4 shows one of the images of the gummy candy of Example 2. Here, the size that satisfies the classification condition of 250 μm<size≤425 μm is defined as middle (“M” in the table).

The gummy candy of Example 2 was examined to measure the number and particle size of carbohydrate crystals under the same conditions as those in Example 1. The average number was 4.33 (pieces), and the average grain size was 0.36 mm.

### Example 3

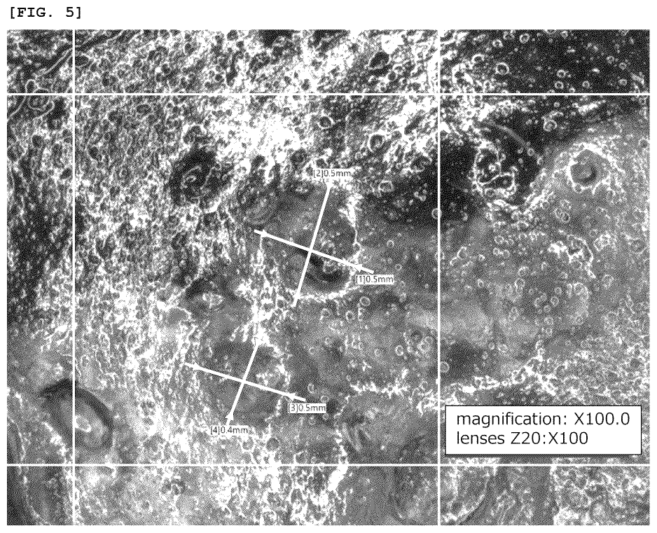

A gummy candy of Example 3 was obtained in the same manner as that in Example 1 except that the erythritol crystals used as the carbohydrate crystals were changed to those that passed through a sieve having a mesh size of 600 μm and did not pass through a sieve having a mesh size of 425 μm. FIG. 5 shows one of the images of the gummy candy of Example 3. Here, the size that satisfies the classification condition of 425 μm<size≤600 μm is defined as Large (“L” in the table).

The gummy candy of Example 3 was examined to measure the number and particle size of carbohydrate crystals under the same conditions as those in Example 1. The average number was 2.33 (pieces), and the average grain size was 0.50 mm.

### Example 4

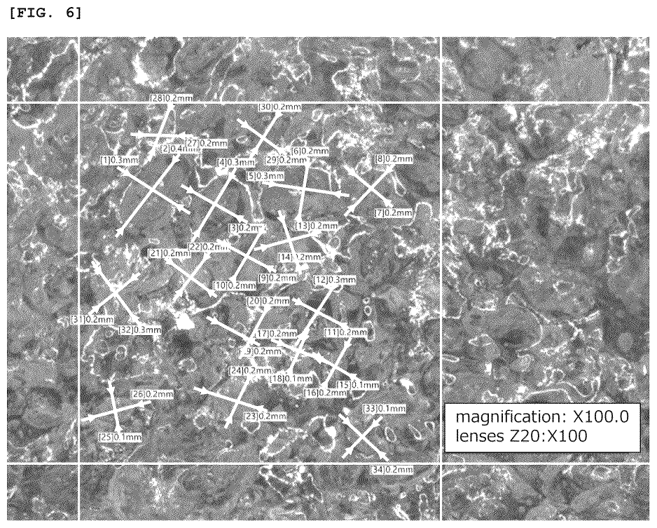

A gummy candy of Example 4 was obtained in the same manner as that in Example 1 except that 38.7 parts by mass of erythritol crystals was mixed as the carbohydrate crystals with 88.3 parts by mass of the gummy base. FIG. 6 shows one of the images of the gummy candy of Example 4.

The gummy candy of Example 4 was examined to measure the number and particle size of carbohydrate crystals under the same conditions as those in Example 1. The average number was 26.00 (pieces), and the average grain size was 0.21 mm.

### Example 5

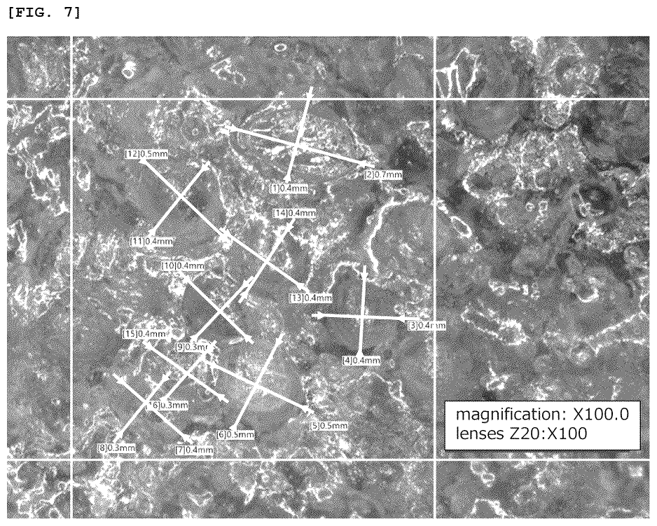

A gummy candy of Example 5 was obtained in the same manner as that in Example 2 except that 38.7 parts by mass of erythritol crystals was mixed as the carbohydrate crystals with 88.3 parts by mass of the gummy base. FIG. 7 shows one of the images of the gummy candy of Example 5.

The gummy candy of Example 5 was examined to measure the number and particle size of carbohydrate crystals under the same conditions as those in Example 1. The average number was 7.67 (pieces), and the average grain size was 0.40 mm.

### Example 6

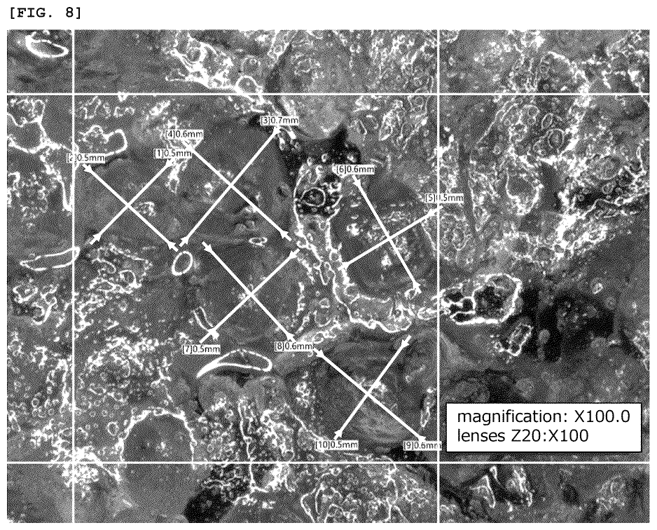

A gummy candy of Example 6 was obtained in the same manner as that in Example 3 except that 38.7 parts by mass of erythritol crystals was mixed as the carbohydrate crystals with 88.3 parts by mass of the gummy base. FIG. 8 shows one of the images of the gummy candy of Example 6.

The gummy candy of Example 6 was examined to measure the number and particle size of carbohydrate crystals under the same conditions as those in Example 1. The average number was 5.00 (pieces), and the average grain size was 0.56 mm.

### Example 7

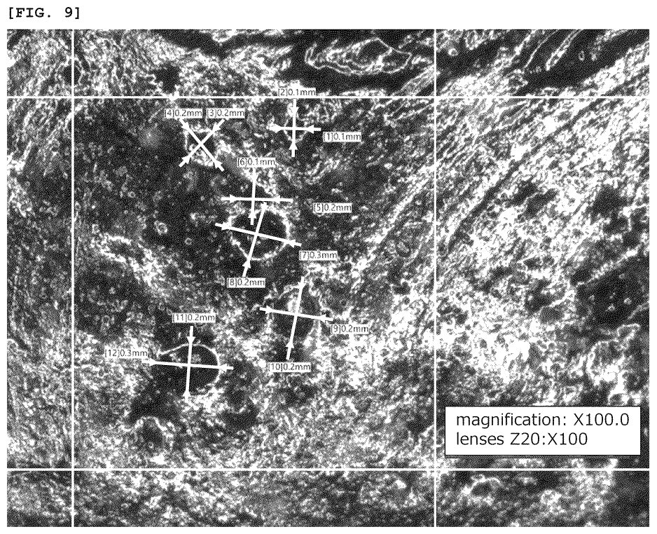

A gummy candy of Example 7 was obtained in the same manner as that in Example 1 except that the carbohydrate crystals to be added to 88.3 parts by mass of the gummy base were changed to trehalose crystals. FIG. 9 shows one of the images of the gummy candy of Example 7.

The gummy candy of Example 7 was examined to measure the number and particle size of carbohydrate crystals under the same conditions as those in Example 1. The average number was 7.00 (pieces), and the average grain size was 0.16 mm.

### Example 8

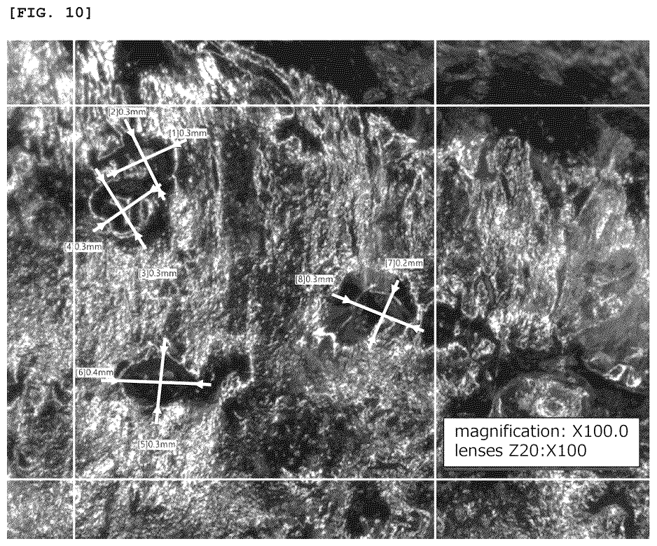

A gummy candy of Example 8 was obtained in the same manner as that in Example 2 except that the carbohydrate crystals to be added to 88.3 parts by mass of the gummy base were changed to trehalose crystals. FIG. 10 shows one of the images of the gummy candy of Example 8.

The gummy candy of Example 8 was examined to measure the number and particle size of carbohydrate crystals under the same conditions as those in Example 1. The average number was 4.67 (pieces), and the average grain size was 0.27 mm.

### Example 9

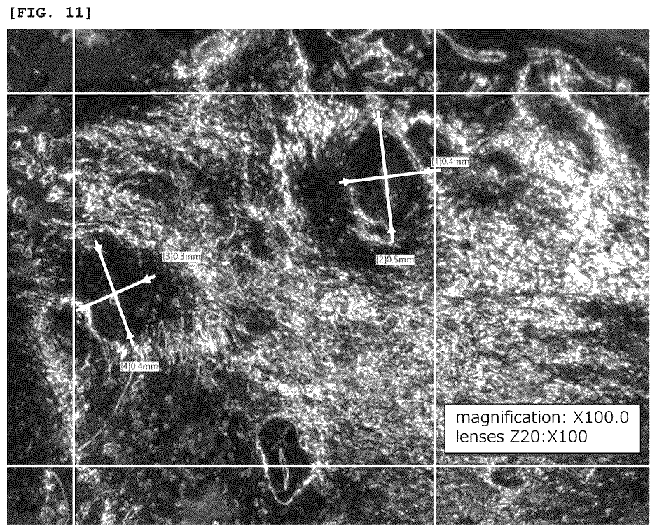

A gummy candy of Example 9 was obtained in the same manner as that in Example 3 except that the carbohydrate crystals to be added to 88.3 parts by mass of the gummy base were changed to trehalose crystals. FIG. 11 shows one of the images of the gummy candy of Example 9.

The gummy candy of Example 9 was examined to measure the number and particle size of carbohydrate crystals under the same conditions as those in Example 1. The average number was 2.67 (pieces), and the average grain size was 0.39 mm.

### Example 10

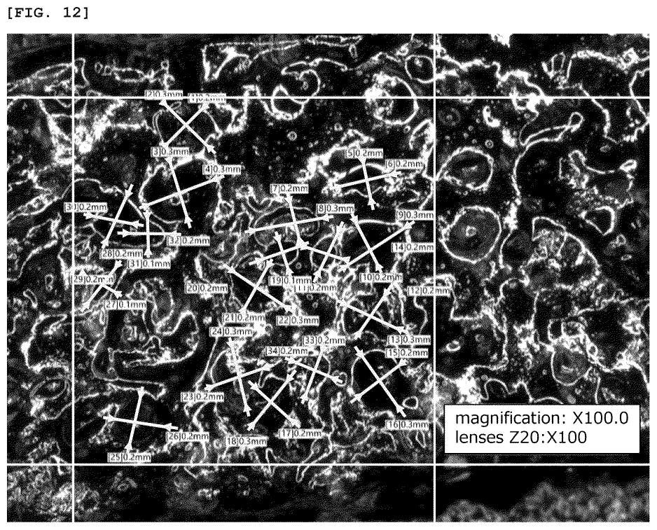

A gummy candy of Example 10 was obtained in the same manner as that in Example 4 except that the carbohydrate crystals to be added to 88.3 parts by mass of the gummy base were changed to trehalose crystals. FIG. 12 shows one of the images of the gummy candy of Example 10.

The gummy candy of Example 10 was examined to measure the number and particle size of carbohydrate crystals under the same conditions as those in Example 1. The average number was 17.67 (pieces), and the average grain size was 0.22 mm.

### Example 11

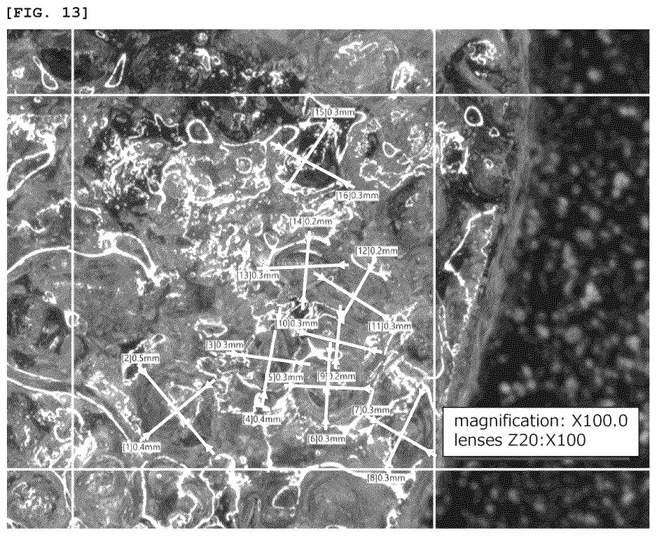

A gummy candy of Example 11 was obtained in the same manner as that in Example 5 except that the carbohydrate crystals to be added to 88.3 parts by mass of the gummy base were changed to trehalose crystals. FIG. 13 shows one of the images of the gummy candy of Example 11.

The gummy candy of Example 11 was examined to measure the number and particle size of carbohydrate crystals under the same conditions as those in Example 1. The average number was 9.33 (pieces), and the average grain size was 0.30 mm.

### Example 12

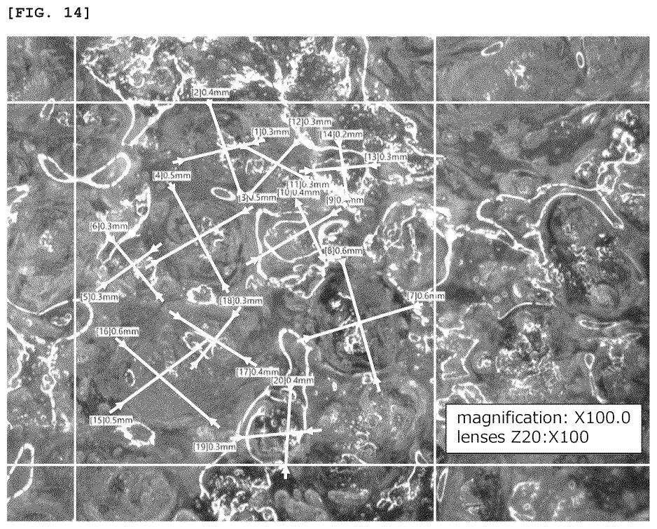

A gummy candy of Example 12 was obtained in the same manner as that in Example 6 except that the carbohydrate crystals to be added to 88.3 parts by mass of the gummy base were changed to trehalose crystals. FIG. 14 shows one of the images of the gummy candy of Example 12.

The gummy candy of Example 12 was examined to measure the number and particle size of carbohydrate crystals under the same conditions as those in Example 1. The average number was 7.33 (pieces), and the average grain size was 0.39 mm.

### Example 13

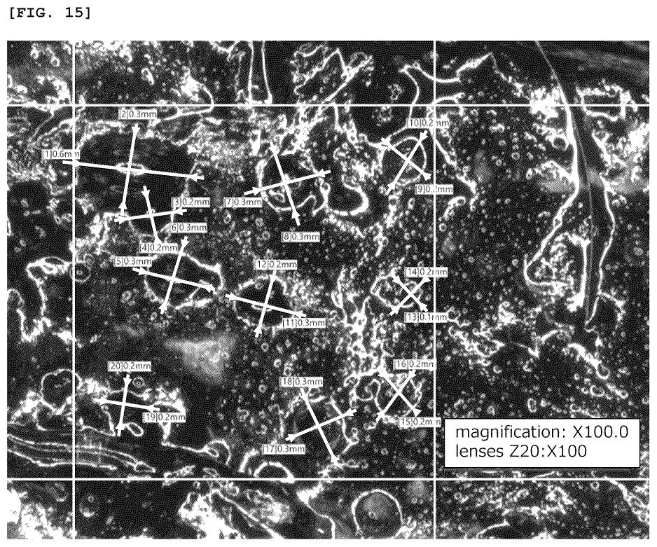

A gummy candy of Example 13 was obtained in the same manner as that in Example 1 except that the carbohydrate crystals to be added to 88.3 parts by mass of the gummy base were changed to crystals of sugar. FIG. 15 shows one of the images of the gummy candy of Example 13.

The gummy candy of Example 13 was examined to measure the number and particle size of carbohydrate crystals under the same conditions as those in Example 1. The average number was 7.67 (pieces), and the average grain size was 0.25 mm.

### Example 14

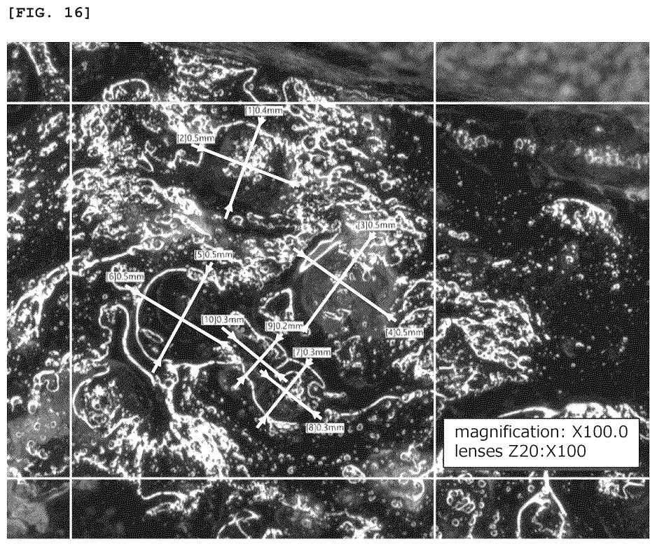

A gummy candy of Example 14 was obtained in the same manner as that in Example 2 except that the carbohydrate crystals to be added to 88.3 parts by mass of the gummy base were changed to crystals of sugar. FIG. 16 shows one of the images of the gummy candy of Example 14.

The gummy candy of Example 14 was examined to measure the number and particle size of carbohydrate crystals under the same conditions as those in Example 1. The average number was 4.00 (pieces), and the average grain size was 0.40 mm.

### Example 15

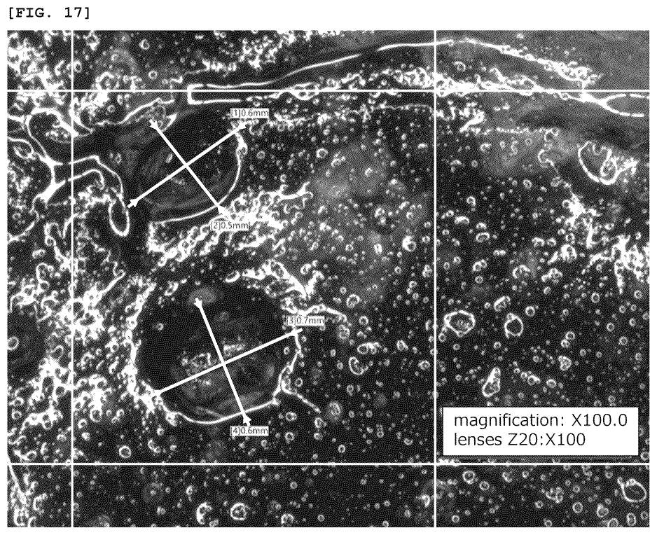

A gummy candy of Example 15 was obtained in the same manner as that in Example 3 except that the carbohydrate crystals to be added to 88.3 parts by mass of the gummy base were changed to crystals of sugar. FIG. 17 shows one of the images of the gummy candy of Example 15.

The gummy candy of Example 15 was examined to measure the number and particle size of carbohydrate crystals under the same conditions as those in Example 1. The average number was 2.67 (pieces), and the average grain size was 0.53 mm.

### Example 16

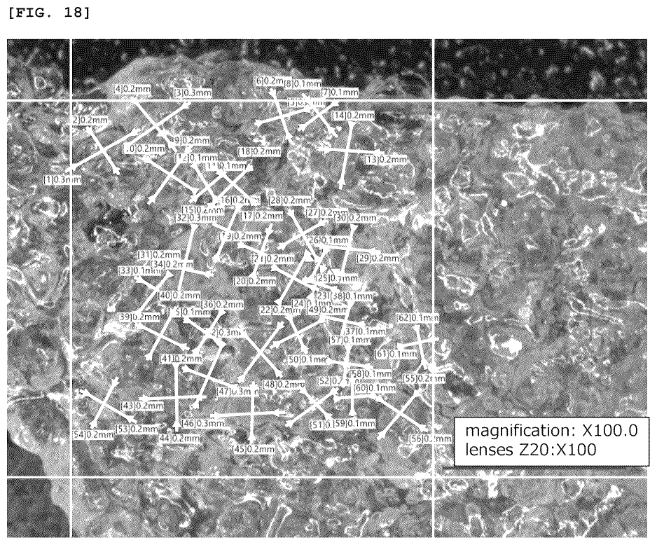

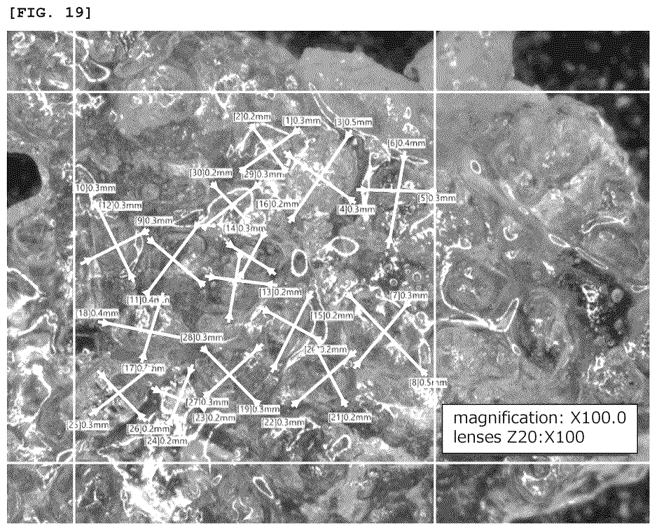

A gummy candy of Example 16 was obtained in the same manner as that in Example 4 except that the carbohydrate crystals to be added to 88.3 parts by mass of the gummy base were changed to crystals of sugar. FIG. 18 shows one of the images of the gummy candy of Example 16.

The gummy candy of Example 16 was examined to measure the number and particle size of carbohydrate crystals under the same conditions as those in Example 1. The average number was 28.00 (pieces), and the average grain size was 0.20 mm.

### Example 17

A gummy candy of Example 17 was obtained in the same manner as that in Example 5 except that the carbohydrate crystals to be added to 88.3 parts by mass of the gummy base were changed to crystals of sugar. FIG. 19 shows one of the images of the gummy candy of Example 17.

The gummy candy of Example 17 was examined to measure the number and particle size of carbohydrate crystals under the same conditions as those in Example 1. The average number was 14.00 (pieces), and the average grain size was 0.26 mm.

### Example 18

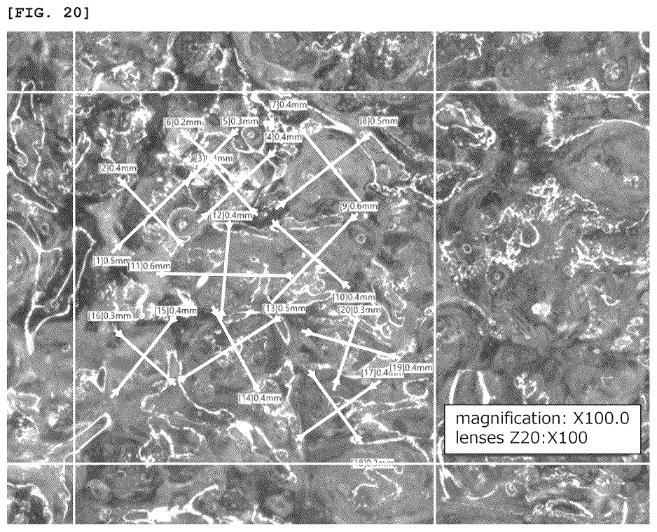

A gummy candy of Example 18 was obtained in the same manner as that in Example 6 except that the carbohydrate crystals to be added to 88.3 parts by mass of the gummy base were changed to crystals of sugar. FIG. 20 shows one of the images of the gummy candy of Example 18.

The gummy candy of Example 18 was examined to measure the number and particle size of carbohydrate crystals under the same conditions as those in Example 1. The average number was 9.67 (pieces), and the average grain size was 0.38 mm.

### Example 19

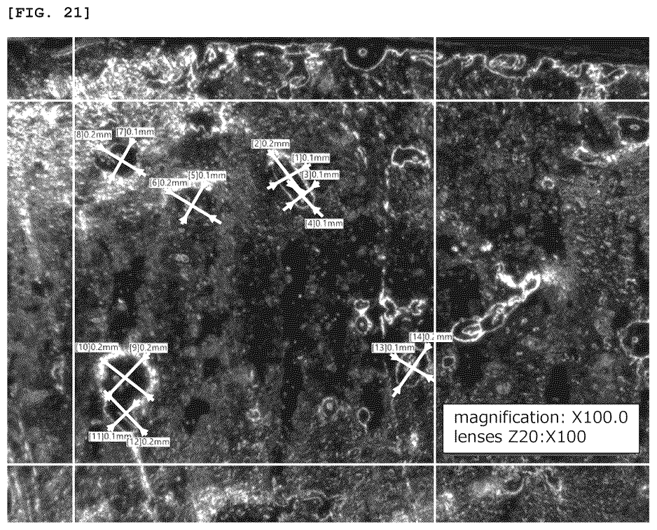

A gummy candy of Example 19 was obtained in the same manner as that in Example 1 except that the carbohydrate crystals to be added to 88.3 parts by mass of the gummy base were changed to maltitol crystals. FIG. 21 shows one of the images of the gummy candy of Example 19.

The gummy candy of Example 19 was examined to measure the number and particle size of carbohydrate crystals under the same conditions as those in Example 1. The average number was 6.67 (pieces), and the average grain size was 0.16 mm.

### Example 20

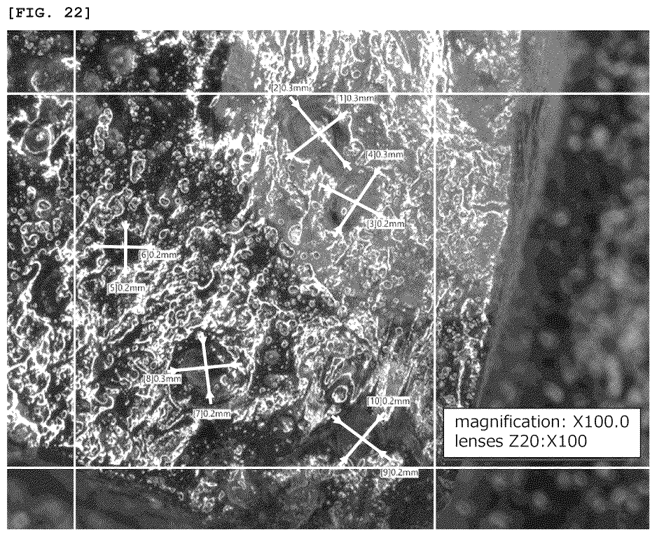

A gummy candy of Example 20 was obtained in the same manner as that in Example 2 except that the carbohydrate crystals to be added to 88.3 parts by mass of the gummy base were changed to maltitol crystals. FIG. 22 shows one of the images of the gummy candy of Example 20.

The gummy candy of Example 20 was examined to measure the number and particle size of carbohydrate crystals under the same conditions as those in Example 1. The average number was 4.67 (pieces), and the average grain size was 0.29 mm.

### Example 21

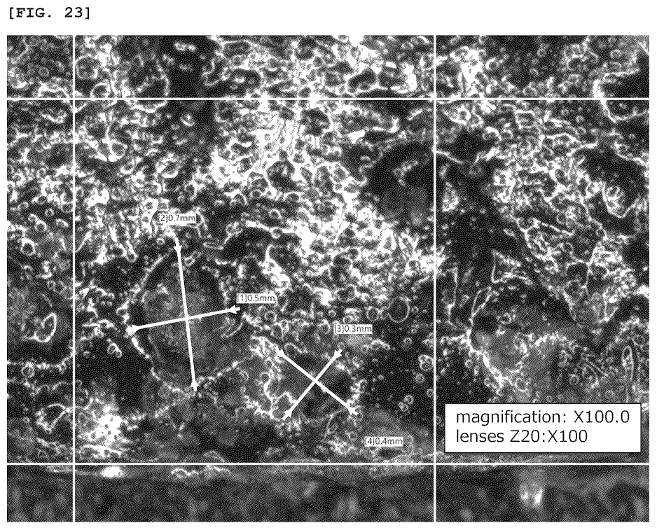

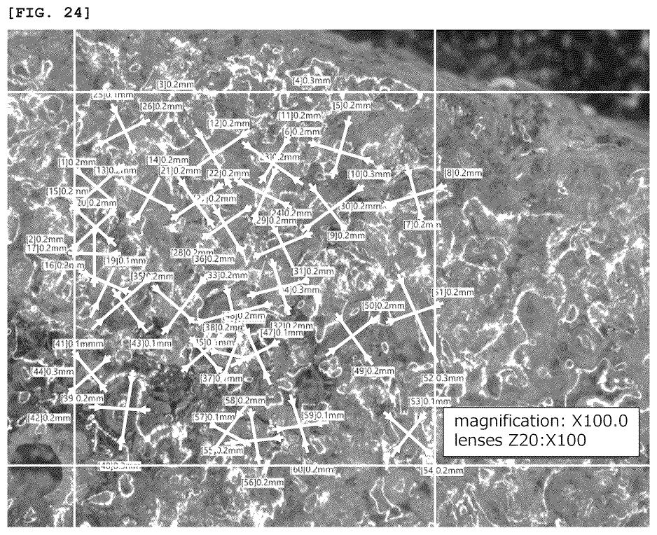

A gummy candy of Example 21 was obtained in the same manner as that in Example 3 except that the carbohydrate crystals to be added to 88.3 parts by mass of the gummy base were changed to maltitol crystals. FIG. 23 shows one of the images of the gummy candy of Example 21.

The gummy candy of Example 21 was examined to measure the number and particle size of carbohydrate crystals under the same conditions as those in Example 1. The average number was 2.67 (pieces), and the average grain size was 0.41 mm.

### Example 22

A gummy candy of Example 22 was obtained in the same manner as that in Example 4 except that the carbohydrate crystals to be added to 88.3 parts by mass of the gummy base were changed to maltitol crystals. FIG. 24 shows one of the images of the gummy candy of Example 22.

The gummy candy of Example 22 was examined to measure the number and particle size of carbohydrate crystals under the same conditions as those in Example 1. The average number was 29.33 (pieces), and the average grain size was 0.20 mm.

### Example 23

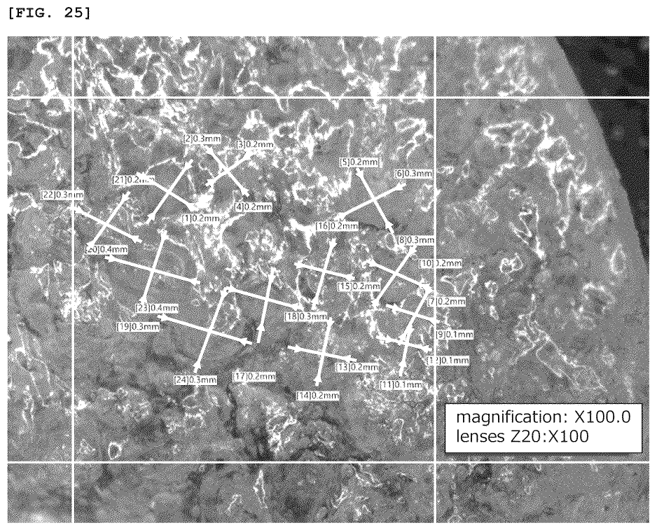

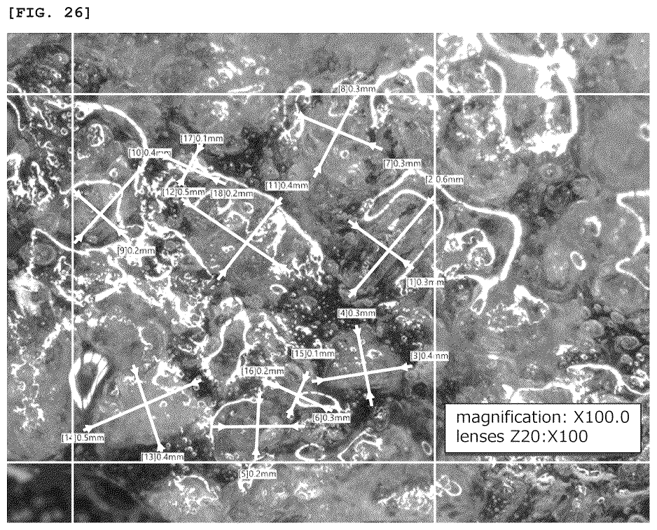

A gummy candy of Example 23 was obtained in the same manner as that in Example 5 except that the carbohydrate crystals to be added to 88.3 parts by mass of the gummy base were changed to maltitol crystals. FIG. 25 shows one of the images of the gummy candy of Example 23.

The gummy candy of Example 23 was examined to measure the number and particle size of carbohydrate crystals under the same conditions as those in Example 1. The average number was 13.33 (pieces), and the average grain size was 0.25 mm.

### Example 24

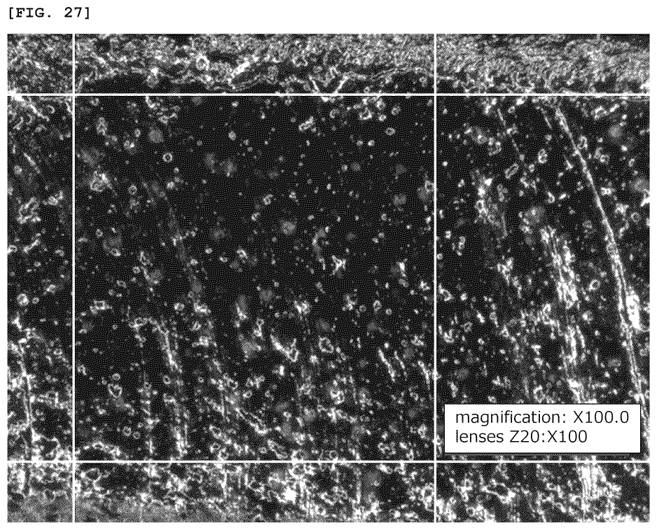

A gummy candy of Example 24 was obtained in the same manner as that in Example 6 except that the carbohydrate crystals to be added to 88.3 parts by mass of the gummy base were changed to maltitol crystals. FIG. 26 shows one of the images of the gummy candy of Example 24.

The gummy candy of Example 24 was examined to measure the number and particle size of carbohydrate crystals under the same conditions as those in Example 1. The average number was 8.67 (pieces), and the average grain size was 0.30 mm.

The average numbers and average particle sizes of the carbohydrate crystals of Examples 1 to 24 are collectively shown in Table 1.

TABLE 1
Average number and average particle size of sugar crystals present within a 4 mm\hat{ }2 (2 mm · 2 mm) frame

| Carbohydrate | | Amount of crystals added: small | | | Amount of crystals added: large | | |
|---|---|---|---|---|---|---|---|
| crystal | | Size: small | Size: medium | Size: large | Size: small | Size: medium | Size: large |
| Erythritol | | Example 1 | Example 2 | Example 3 | Example 4 | Example 5 | Example 6 |
| | Average number (pieces) | 5.33 | 4.33 | 2.33 | 26.00 | 7.67 | 5.00 |
| | Average particle size (mm) | 0.21 | 0.36 | 0.50 | 0.21 | 0.40 | 0.56 |
| Trehalose | | Example 7 | Example 8 | Example 9 | Example 10 | Example 11 | Example 12 |
| | Average number (pieces) | 7.00 | 4.67 | 2.67 | 17.67 | 9.33 | 7.33 |
| | Average particle size (mm) | 0.16 | 0.27 | 0.39 | 0.22 | 0.30 | 0.39 |
| Sugar | | Example 13 | Example 14 | Example 15 | Example 16 | Example 17 | Example 18 |
| | Average number (pieces) | 7.67 | 4.00 | 2.67 | 28.00 | 14.00 | 9.67 |
| | Average particle size (mm) | 0.25 | 0.40 | 0.53 | 0.20 | 0.26 | 0.38 |
| Maltitol | | Example 19 | Example 20 | Example 21 | Example 22 | Example 23 | Example 24 |
| | Average number (pieces) | 6.67 | 4.67 | 2.67 | 29.33 | 13.33 | 8.67 |
| | Average particle size (mm) | 0.16 | 0.29 | 0.41 | 0.20 | 0.25 | 0.30 |

### Comparative Example 1

A gummy candy of Comparative Example 1 was obtained in the same manner as that in Example 1 except that the carbohydrate crystals were not mixed with the gummy base. FIG. 27 shows one of the images of the gummy candy of Comparative Example 1.

### Comparative Example 2

### (1) Gummy Dough A

To a mixture containing 44.4 parts by mass of starch syrup, 31.0 parts by mass of sugar, 0.8 parts by mass of sorbitol, 4.9 parts by mass of gelatin, and 0.1 parts by mass of pectin, the same amount of erythritol as that of the carbohydrate crystals in Example 4 was mixed. Then, 14.3 parts by mass of water was added thereto and mixed together. The mixture was boiled down, so that the Brix value thereof was adjusted to B×81. After that, 1.4 parts by mass of other additives and 3.1 parts by mass of water were added to adjust the Brix value thereof to B×80, and as a result, a gummy dough A was obtained.

### (2) Filling and Molding

A starch mold was filled with the gummy dough A using a dropper and was left standing until the gummy dough A was sufficiently dried. After the gummy dough A was sufficiently solidified and dried, the gummy candy was taken out from the starch mold, and a release oil composed of a vegetable fat or oil and a brightener was applied to the surface of the gummy candy to obtain a gummy candy of Comparative Example 2.

### (3) Classification of Carbohydrate Crystals

Erythritol used in Comparative Example 2 was not subjected to classification of the carbohydrate crystals.

### (4) Cross-Sectional Observation

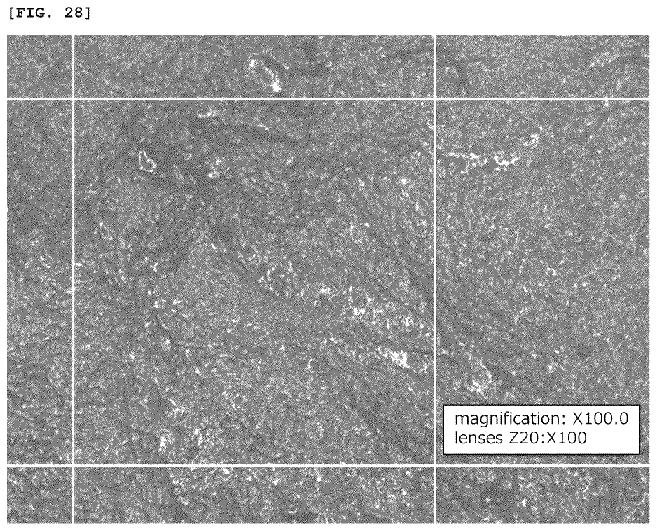

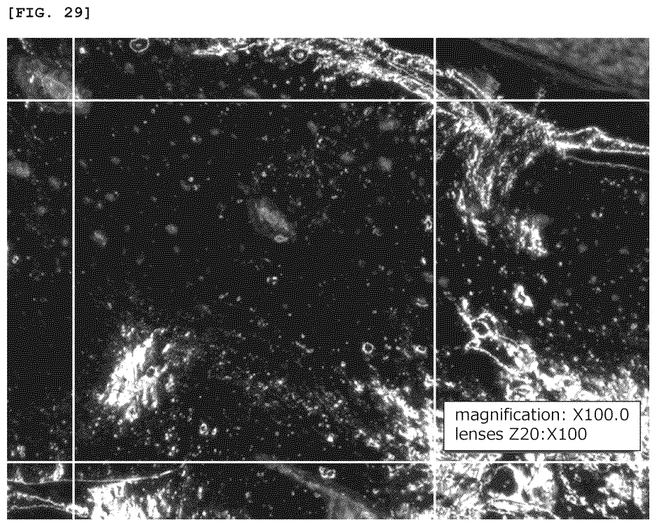

The gummy candy of Comparative Example 2 was cut with a cutter to prepare three cut pieces having a thickness of 1 mm from an optional inner region of the gummy candy. Using a digital microscope (KEYENCE VHX-970FN manufactured by KEYENCE CORPORATION), the cross section of each cut side was captured at a magnification of 100. One of the microscopic images obtained is shown in FIG. 28. For each of the captured images, the number and particle size of the carbohydrate crystals present within a 4 mm\hat{ }2 (2 mm×2 mm) frame were measured. No measurable carbohydrate crystals of 0.1 mm or larger were found in the captured images.

### Comparative Example 3

A gummy candy of Comparative Example 3 was obtained in the same manner as that in Comparative Example 2 except that the carbohydrate crystals to be used in the gummy dough A was changed to trehalose crystals. FIG. 29 shows one of the images of the gummy candy of Comparative Example 3. No measurable carbohydrate crystals were found in the captured images.

### Comparative Example 4

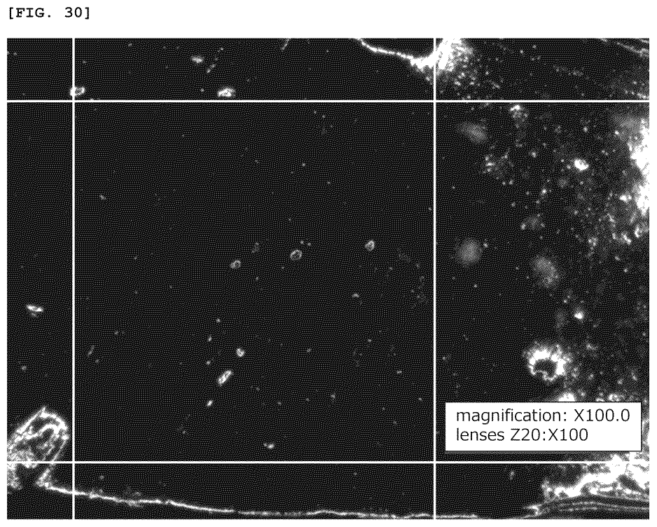

A gummy candy of Comparative Example 4 was obtained in the same manner as that in Comparative Example 2 except that the carbohydrate crystals to be used in the gummy dough A was changed to crystals of sugar. FIG. 30 shows one of the images of the gummy candy of Comparative Example 4. No measurable carbohydrate crystals were found in the captured images.

### Comparative Example 5

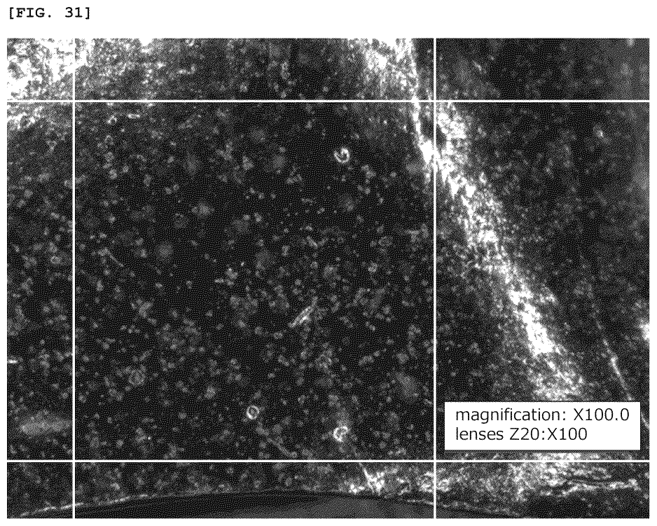

A gummy candy of Comparative Example 5 was obtained in the same manner as that in Comparative Example 2 except that the carbohydrate crystals to be used in the gummy dough A was changed to maltitol crystals. FIG. 31 shows one of the images of the gummy candy of Comparative Example 5. No measurable carbohydrate crystals were found in the captured images.

### Sensory Evaluation Test

### (1) Criteria for Crunchy Texture

The crunchy texture of the gummy candy was evaluated based on a 5-point scale: 5: strong crunchy texture, 4: crunchy texture, 3: slight crunchy texture, 2: almost no crunchy texture, 1: no crunchy texture. The texture of the gummy candy of Comparative Example 1 (without addition of carbohydrate crystals) was used as a standard of comparison for evaluation 1.

### (2) Criteria for Gummy-Like Texture

The gummy-like texture of the gummy candy was evaluated based on a 5-point scale: 5: strong gummy-like texture, 4: gummy-like texture, 3: slight gummy-like texture, 2: almost no gummy-like texture, 1: no gummy-like texture. The texture of the gummy candy of Comparative Example 1 (without addition of carbohydrate crystals) was used as a standard of comparison for evaluation 1.

For the above two types of evaluation, five evaluators were selected to evaluate Examples 1 to 24 and Comparative Examples 1 to 5. The evaluation results are shown in Table 2.

TABLE 2
Erythritol

| | | | Amount of crystals added: small | | | Amount of crystals added: large | | |
|---|---|---|---|---|---|---|---|---|
| | Comparative | Comparative | Size: small | Size: medium | Size: large | Size: small | Size: medium | Size: large |
| Average | example 1 | example 2 | Example 1 | Example 2 | Example 3 | Example 4 | Example 5 | Example 6 |
| Crunchy texture | 1.0 | 1.6 | 2.4 | 2.8 | 3.4 | 3.8 | 4.4 | 4.8 |
| Gummy-like texture | 5.0 | 2.6 | 5.0 | 5.0 | 4.8 | 3.4 | 3.4 | 3.2 |

Trehalose

| | | | Amount of crystals added: small | | | Amount of crystals added: large | | |
|---|---|---|---|---|---|---|---|---|
| | Comparative | Comparative | Size: small | Size: medium | Size: large | Size: small | Size: medium | Size: large |
| Average | example 1 | example 3 | Example 7 | Example 8 | Example 9 | Example 10 | Example 11 | Example 12 |
| Crunchy texture | 1.0 | 1.6 | 1.6 | 2.8 | 3.4 | 3.6 | 4.2 | 5.0 |
| Gummy-like texture | 5.0 | 3.6 | 4.8 | 4.8 | 4.6 | 3.8 | 3.4 | 3.2 |

Sugar

| | | | Amount of crystals added: small | | | Amount of crystals added: large | | |
|---|---|---|---|---|---|---|---|---|
| | Comparative | Comparative | Size: small | Size: medium | Size: large | Size: small | Size: medium | Size: large |
| Average | example 1 | example 4 | Example 13 | Example 14 | Example 15 | Example 16 | Example 17 | Example 18 |
| Crunchy texture | 1.0 | 1.8 | 2.0 | 3.2 | 4.0 | 4.6 | 4.8 | 5.0 |
| Gummy-like texture | 5.0 | 3.8 | 4.6 | 4.6 | 4.6 | 3.2 | 3.0 | 2.8 |

Maltitol

| | | | Amount of crystals added: small | | | Amount of crystals added: large | | |
|---|---|---|---|---|---|---|---|---|
| | Comparative | Comparative | Size: small | Size: medium | Size: large | Siz: small | Size: medium | Size: large |
| Average | example 1 | example 5 | Example 19 | Example 20 | Example 21 | Example 22 | Example 23 | Example 24 |
| Crunchy texture | 1.0 | 1.0 | 1.4 | 2.4 | 3.2 | 4.0 | 4.4 | 4.8 |
| Gummy-like texture | 5.0 | 3.0 | 4.6 | 4.5 | 4.2 | 3.2 | 3.2 | 3.2 |

As shown in Table 2, in all of Examples 1 to 3, the amount of carbohydrate crystals added was smaller than that in Comparative Example 2. However, the texture was equally crunchy or even more so compared with that of Comparative Example 2, and also exhibited a gummy-like texture. In Examples 4 to 6, as compared with Comparative Example 2, the gummy candies had a good crunchy texture, and also a good gummy-like texture.

In all of Examples 7 to 9, the amount of carbohydrate crystals added was smaller than that in Comparative Example 3. However, the texture was equally crunchy or even more so compared with that of Comparative Example 3, and also exhibited a gummy-like texture. In Examples 10 to 12, as compared with Comparative Example 3, the gummy candies had a good crunchy texture, and also a good gummy-like texture.

In all of Examples 13 to 15, the amount of carbohydrate crystals added was smaller than that in Comparative Example 4. However, the texture was equally crunchy or even more so compared with that of Comparative Example 4, and also exhibited a gummy-like texture. In Examples 16 to 18, as compared with Comparative Example 4, the gummy candies had a good crunchy texture, and also a good gummy-like texture.

In all of Examples 19 to 21, the amount of carbohydrate crystals added was smaller than that in Comparative Example 5. However, the texture was equally crunchy or even more so compared with that of Comparative Example 5, and also exhibited a gummy-like texture. In Examples 22 to 24, as compared with Comparative Example 5, the gummy candies had a good crunchy texture, and also a good gummy-like texture.

From the above-described results, it was found that, according to the present disclosure, even when the amount of carbohydrate crystals added is small, the resulting gummy candy exhibits a good crunchy texture and a good gummy-like texture. It was also found that when the amount of carbohydrate crystals added is the same, the resulting gummy candy exhibits a good crunchy texture and a good gummy-like texture.

It will be apparent to those skilled in the art that various modifications and variations can be made in the present disclosure without departing from the spirit or scope of the present disclosure. Thus, it is intended that the present disclosure covers the modifications and variations of the present disclosure provided they come within the scope of the appended claims and their equivalents. All related art references described above are hereby incorporated in their entirety by reference.

What is claimed is:

1. A method for producing a gummy candy, comprising:
a gummy base preparation step of heating a carbohydrate raw material and a gelling agent to obtain a gummy base;
an addition step of adding carbohydrate crystals to the gummy base to obtain a gummy dough; and
a drying step of filling a mold with the gummy dough and drying the gummy dough.

2. A gummy candy produced by the method for producing a gummy candy according to claim 1, wherein
the carbohydrate crystals are crystals of at least one selected from the group consisting of erythritol, trehalose, sugar, and maltitol.

3. The gummy candy according to claim 2, wherein the carbohydrate crystals have a size that keeps them from passing through a sieve having a mesh size of 150 μm.

4. The gummy candy according to claim 2, wherein the carbohydrate crystals have a size that allows them to pass through a sieve having a mesh size of 600 μm and that keeps them from passing through a sieve having a mesh size of 150 μm.

5. A gummy candy comprising carbohydrate crystals, wherein:
when the gummy candy is cut and a cross section of an inner region of the gummy candy is observed with an optical microscope at a magnification of 100,
two or more of the carbohydrate crystals having a particle size of 0.2 mm or more are present in an arbitrary 2 mm×2 mm region.

6. The gummy candy according to claim 5, wherein the carbohydrate crystal is a crystal of erythritol.

7. The gummy candy according to claim 5, wherein the carbohydrate crystal is a crystal of trehalose.

8. The gummy candy according to claim 5, wherein the carbohydrate crystal is a crystal of sugar.

9. The gummy candy according to claim 5, wherein the carbohydrate crystal is a crystal of maltitol.
